(19) United States
(12) Patent Application Publication
(10) Pub. No.: US 2001/0016223 A1
(43) Pub. Date: Aug. 23, 2001

(54) Process and equipment for the manufacture of edible spreads

(76) Inventors: Jacobus Eendenburg Van, Vlaardingen (NL); Cornelis Hollander Den, Vlaardingen (NL); Hendrik Johannes Human, Vlaardingen (NL); Jo Janssen, Vlaardingen (NL)

Correspondence Address: UNILEVER, PATENT DEPARTMENT, 45 RIVER ROAD, EDGEWATER, NJ, 07020, US

(21) Appl. No.: 09/737,377

(22) Filed: Dec. 15, 2000

(30) Foreign Application Priority Data
Dec. 16, 1999 (EP) 99204358.8

(51) Int. Cl. A23D 7/00

(52) U.S. Cl. 426/603; 426/601

(57) ABSTRACT

A process for the manufacture of an edible plastic W/O-emulsion spread using common spread starting materials and employing a traditional spread processing line comprising mixing and cooling devices, except that for the final cooling and crystallizing step a single-screw cooler with a special very tight clearance of screw and barrel is employed. The single-screw cooler allows controlled working and deep cooling of the spread material.

The present invention deals with a process for the manufacture of margarine and other fat continuous emulsion spreads and with equipment for carrying out such process.

### BACKGROUND OF THE INVENTION

A typical manufacturing process for edible fat continuous emulsion spreads such as margarine, starts with an aqueous phase and a fat phase in which phases the spread ingredients have been dissolved.

Common processing lines for spread manufacture comprise devices for mixing, emulsifying, cooling, particularly scraped surface heat exchangers and devices for working and crystallizing the cooled emulsion, particularly pin stirrers. Resting tubes are inserted in the line for increasing residence time and for allowing the cooled emulsion to crystallize and plasticize under quiescent conditions.

The process results in a spread product in which a network of fat crystals stabilizes the emulsion. The design of a spread manufacturing process aims at—inter alia—an optimum average size and size distribution of the emulsion's aqueous phase droplets and a proper product hardness at the moment of packing.

Scraped surface heat exchangers are cooling devices provided with blades mounted on a central axis. During processing of the emulsion the blades scrape the solidified fat from the inner surface of the liquid ammonia cooled wall. For cooling this type of crystallising matter those scraped surface heat exchangers are very effective. However, when crystallisation of the fat phase proceeds, effectivity drops due to viscous energy dissipation.

A pin stirrer acts as a stirring and working device. Their effect is based on shear caused by protruding pins mounted on a central axis which rotates with a speed which may be adapted to the desired extent of working. With a pin stirrer the crystallisation of the fat phase can be controlled.

A margarine manufacturing line according to the present state of the art contains scraped surface heat exchangers as well as pin stirrers in a number and in an order which is dictated by the properties wanted for the final product.

Alternative cooling devices are tubular heat exchangers and cooling coils that use cold or ice water. For emulsifying a homogenizer, a colloid mill or a pressure valve may be employed, instead of or besides pin stirrers.

Detailed information for margarine manufacturing technology can be found in actual textbooks, e.g. (Bailey's Industrial Fat and Oil Products, Vol.4, Chapter 10, “Margarine Processing Plants and Equipment” by K. A. Alexandersen, New York 1996, Wiley & Sons Inc.)

A few prior art references mention still other types of margarine manufacturing equipment. According to Japanese patent JP 61/289838 margarine can be prepared with a double shafted extruder which is provided with two cooperating screws, a so-called twin screw. Such equipment is chosen for food processing when thorough mixing of viscous matter is wanted. All functions for margarine processing: heating, blending, emulsification, cooling, kneading and crystallization are said to be performed in this single device. Although the reference hardly contains product qualifications, it is clear that the characteristic high shear which intentionally is generated in a twin-screw is disturbing the delicate network of fat crystals and consequently decreases the hardness of the product.

The art of processing the spread has a great impact on taste, mouthfeel, consistency and stability of the final product. Although great progress has been made in the long history of margarine manufacture, for margarine and other fat-continuous emulsion spreads still many improvements of the consistency and of the organoleptic properties are desired.

A typical manufacturing process of margarine, and of other fat continuous emulsion spreads, may proceed as follows: in separate storage vessels the fat phase and the aqueous phase are prepared by mixing the usual ingredients. Metering pumps transfer the mixtures of the two phases in the correct ratio to a pre-mix vessel where the aqueous and the fat phases are combined into a coarse pre-emulsion. This coarse pre-emulsion is pumped into the manufacturing line and subjected to various consecutive treatments comprising emulsification, cooling, working and crystallization. The result is a more or less liquid intermediate emulsion which subsequently is crystallized and finally yields the desired spread. The consecutive treatments change the consistency of the product, particularly when the intermediate emulsion approaches the end of the line where it becomes increasingly more viscous and finally even plastic by proceeding crystallisation of the fat phase.

The process for transformation of the more or less liquid intermediate emulsion into an acceptable spread product still is far from ideal. Presently a scraped surface heat exchanger (SSHE) at the end of the line is used for cooling and crystallizing the intermediate emulsion. However, it is difficult to control the working effect of the SSHE during this final cooling step. If the intermediate emulsion starts with too little pre-crystallisation, that working will be insufficient and the product, although having adequate hardness, will have a poor, brittle structure. When to the contrary the intermediate emulsion starts with too much pre-crystallisation, the spread will be overworked and a too soft product or no spread-like product at all will result. So it is difficult to control the effect of working.

Further, the cooling functionality of the SSHE fails increasingly when the crystallisation of the spread proceeds and its viscosity grows. The consequence is that it is not very well possible to cool the product to temperatures below 10° C. It is even impossible to attain packing temperatures of 5° C. which in future will be demanded by the margarine and spreads retail business.

The present invention addresses those problems and has provided a solution.

### SUMMARY OF THE INVENTION

The invention consists of a processing line that is suited for the manufacture of edible W/O emulsion spreads and which line consists of at least two connected mixing and cooling devices through which line the starting materials for preparing a spread can be conducted consecutively for processing, characterised in that one of the cooling devices is a single-screw cooler of the type that is provided with a screw mounted in a barrel, where the distance of the flight of the screw to the inner wall of the barrel is 0.1-2 mm.

The invention also provides a process for the manufacture of an edible fat continuous emulsion spread from usual ingredients, which process comprises a first treatment and a subsequent second treatment, where the first treatment consists of mixing the usual spread starting materials followed by a usual series of consecutive steps comprising emulsifying, cooling, crystallizing and working treatments in any suitable order and number for obtaining an intermediate liquid fat continuous emulsion, and where the second treatment of the process comprises cooling the intermediate emulsion in such way that it crystallizes and changes into a plastic emulsion spread and which process is characterised in that the cooling of the intermediate emulsion is performed by conducting it through a single-screw cooler of the type that is provided with a screw mounted in a barrel, where the distance of the flight of the screw to the inner wall of the barrel is 0.1-2 mm and, optionally, through a subsequent resting tube.

### SHORT DESCRIPTION OF THE FIGURES

FIGS. 1 and 2 show schematical views of spread manufacturing lines.

FIG. 1 shows a traditional spread manufacturing line containing vessels P for storing the prepared coarse pre-emulsion, a scraped surface heat exchangers (A), a pin stirrer (C), two other scraped surface heat exchangers (A), a resting tube (B) and finally a packing machine (PM). Also a rework line (RM) and pumps (triangles) are shown.

FIG. 2 shows a manufacturing line according to the invention. That line is very similar to the line of FIG. 1, but a single-screw cooler (S) has substituted the scraped surface heat exchangers at the end of the line. The meaning of the other signs is the same as in FIG. 1.

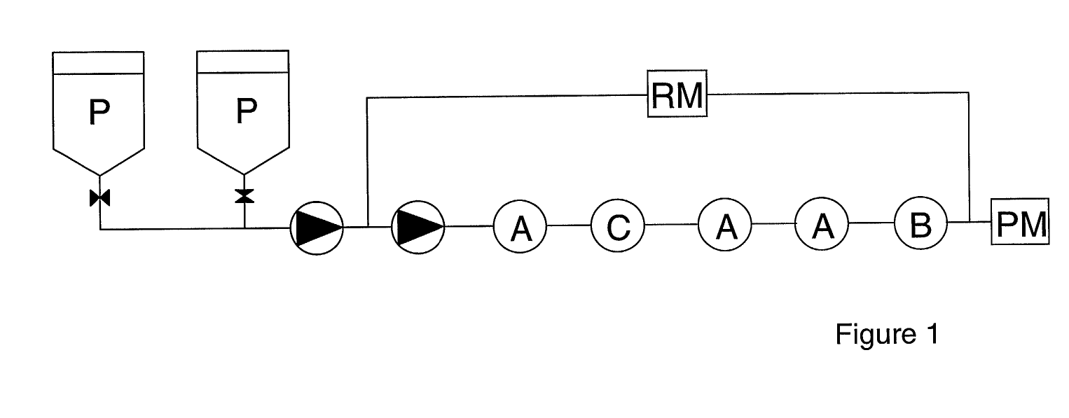

### DETAILS OF THE INVENTION

A single-screw cooler is a device which consists of a screw in the form of a helix mounted on a central axis which can revolve in a barrel. Since long single-screw extruders are employed primarily for the transport of fluid matter, even highly plastic matter which may be food or non-food. The screws in the ancient, still simple single-screw extruders are sometimes denoted as Archimedean screws and originally are used for transport purposes only.

The single-screw extruder has become a single-screw cooler when it is provided with cooling means, in the form of a double wall through which a cooling liquid, e.g. ice water, cooled brine, liquid ammonia or freon can be conducted.

Single-screw coolers are known devices which have been appreciated mainly for effectively transporting and far less for cooling fluid materials, including food compositions. They are used as ice-cream dispensing machines. In the manufacture of non-fluid fat-continuous emulsion spreads, however, their lack of cooling functionality has prohibited actual use. Until the present invention, the single-screw cooler was not employed as cooling device for the crystallisation of viscous spread emulsions.

It should be noted that a spread has to comply with high standards with respect to appearance and texture, which properties are strongly influenced by the consecutive processing steps, particularly the final treatment with the cooling device at the end of the manufacturing line.

For a proper performance it is essential that the single-screw cooler employed in the present invention is able to cool effectively a highly viscous emulsion spread, while conveying it through the device. Effectively in this respect means that the cooling results in a lattice structure of crystallised fat which determines the desired spread's consistency and mouthfeel. Such cooling performance can not be obtained with common single-screw coolers, none of which possesses a <2 mm distance between the flight of the screw and the inner wall of the barrel (which distance is denoted as clearance).

A single-screw cooler being a part of an ice-cream device is described in WO 98/09536. It has a clearance of a tenth of an inch, which is 2.54 mm.

It is the merit of the present invention to have recognized the feature which is essential for turning a common single-screw cooler into a most useful part of an improved spread manufacturing line. This feature is the clearance to be chosen unusual small. A tight fitting of the screw in the barrel has appeared to be essential for a proper cooling performance of the viscous spread emulsion.

The high precision needed for building a single-screw cooler with such tight fitting increases its production costs. The manufacture of such expensive single-screw cooler is justified only when the envisaged use requires the tight fitting.

The single-screw cooler to be used in the present invention possesses the critical flight clearance of 0.1-2 mm, preferably 0.1-1 mm, more preferably, 0.1-0.5 mm. Such narrow clearance has appeared to determine the effectiveness of the cooling of fat continuous spread emulsions. It is the feature which distinguishes the present device from other types of single-screw coolers which use would make the present invention fail.

A single-screw cooler when operating generates little shear energy so that the spread does not suffer from warming up or getting overworked. This is in contrast to multiple screw coolers, such as the twin-screw coolers mentioned above, which are appreciated for effective mixing because of high shear generation. Inevitably, the shear of such devices would adversely affect the vulnerable crystalline structure of the spread. Moreover, the construction of multiple-screws can not match the superior cooling functionality of the single-screw coolers of the present invention.

In still another aspect a single-screw device is superior over twin screws because the simpler construction results into enhanced reliability.

Often the performance of the single-screw cooler can be improved by connecting it to a subsequent resting tube. When fat crystallisation is not yet complete at the exit of the single-screw cooler, the cooled spread, by proceeding through the resting tube, is allowed extra residence time for completing its crystallisation process under quiescent conditions.

In the present invention the single-screw cooler is not only a very effective cooling device but also an effective low shear conveyor of viscous materials, so that line pressure can remain low and a high energy pump can be dispensed with.

By employing a single-screw cooler the spread can be subjected to the deep and prolonged cooling needed for realizing the desired packaging hardness in the line without the need of post-cooling in a warehouse. It is possible to cool the spread to temperatures as low as 5° C. and even less, which is beyond possibilities of state of the art spread manufacturing equipment. The cooled spread when delivered by the line and packed is ready for transport to retailers.

Preferably, the spread is cooled so far that a Stevens value for hardness is attained which is at least 30 g when the spread is meant for packaging in a tub or at least 160 g when it is meant for packaging in a wrapper. Stevens values for hardness are established according to the protocol described in the experimental part of this specification.

Although the single-screw cooler is particularly suited for processing high-fat spreads which are particularly sensitive for overworking, such as 80% fat containing margarine, it is suited as well for the manufacture of spreads having lower fat contents, even as low as 35 wt. %. Generally, the softer consistency of such low-fat spreads needs deeper cooling for proper packaging. The present invention allows cooling the spread to the optimum temperature for obtaining packing hardness.

Preferably the process of the invention is carried out in such way that the intermediate emulsion has sufficient stability that it will not suffer from a short flow interruption. Stability means that no visible phase separation occurs when the emulsion is left to quiescent conditions up to half an hour, preferably up to one hour. This is effected by cooling the intermediate emulsion only slightly and to such extent that in the continuous fat phase just enough fat crystals are produced to surround and protect the aqueous phase droplets from coalescing.

The steps of the first treatment of the process are according to traditional common technology and need no further explanation or specification. They are chosen such that the intermediate emulsion has a dispersed aqueous phase with a proper average droplet size and droplet size distribution. In this context proper means that in the final cooling part of the process no further treatments are necessary for improving the quality of the dispersed aqueous phase. In the intermediate emulsion product and in the final product a proper average size for the aqueous phase droplets is in the range 2-20 μm.

The devices for preparing the intermediate emulsion are chosen from those known from traditional, common spread manufacturing technology (see Alexandersen, supra), comprising, for example, scraped surface heat exchangers, cooling coils, tubular heat exchangers, twin screw, pin stirrers, homogenizers, colloid mills and pressure valves. They are employed according to current spread manufacturing technology. A proven treatment sequence is the A-A-A-C sequence where A denotes a scraped surface heat exchanger and C denotes a pin stirrer. Other known sequences may do as well. The processing proceeds at such temperatures that the resulting intermediate emulsion is liquid, although preferably a small part of the fat phase may be present in crystallized form as said before.

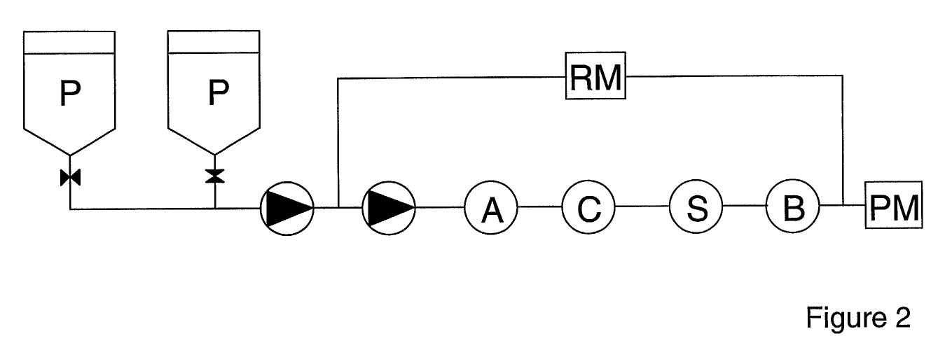

Any scraped surface heat exchanger or pin stirrer in the first section of the line as illustrated by FIG. 2 may be replaced by a device having comparable functionality, provided the said liquid intermediate emulsion is delivered.

The ingredients for the liquid W/O-emulsion are not different from the common ones for spread manufacture. The aqueous phase which comprises 15-90 wt. % of the emulsion, may contain, besides water, proteins such as whey powder and skimmed milk powder, structuring agents, thickening agents and gelling agents such as gelatine, an edible acid, such as lactic acid, a preservative such as potassium sorbate.

The fat phase which comprises 10-85 wt. % of the emulsion, contains a suitable fat blend, such as sunflower oil including structuring fats like an interesterified mixture of palm stearin and palm kernel stearin. Suitable fat phase ingredients are further emulsifiers like lecithin and monoglycerides, flavour, colour such as beta-carotene. See for general information about ingredients and processing the already mentioned textbook and also The Chemistry and Technology of Edible Oils and Fats and their High Fat Products (G. Hoffmann; Academic Press London, 1989, page 319 ff).

For carrying out the present invention one has to avail of a single-screw cooler having a flight clearance of 0.1-2 mm. If not commercially available, it can be built without undue effort and with the common skills of the experienced machine engineer who is familiar with single-screw coolers.

Besides the spread manufacturing benefits of the single-screw cooler also its safety and environmental aspects should be mentioned. Harmless brine or ice water suffice as cooling medium. One can dispense with the dangerous and expensive liquid ammonia which necessarily is employed in current scraped surface heat exchangers.

Spreads produced with a single-screw cooler often show better product properties such as better appearance, texture and taste. Particularly improvements with respect to (yellow) colour, gloss, good spreading and (mouth) melting properties, less grainy and lumpy mouthfeel, creaminess, flavour intensity, less intense off-flavour notes and a longer lingering taste have been noted.

Summarizing the benefits and advantages of spread manufacture using a single-screw cooler:

Effective cooling of spread flow even when highly viscous,

Effective conveying of a viscous spread flow,

Production process is easy to control and has a large operating window,

Relatively cheap equipment,

Control of line pressure at an acceptable level,

Product packing at a temperature as low as 2° C.,

Little shear during cooling results in better hardness of end product,

Improved product consistency and better organoleptic properties,

Harmless and environment friendly cooling medium.

### Protocol For Measurement of Stevens Values

The spread is equilibrated at the measuring temperature for 24 hours. The “Stevens” hardness S(t) at temperature t, expressed in grams, is measured in a Stevens-LFRA Texture Analyser (ex Stevens Advanced Weighing Systems, Dunmore, U.K.). Measurement specification: 4.4 mm diameter cylinder; load range 1000 g; device operated “normal” and set at 10 mm penetration depth and 2.0 mm/s penetration rate.

The invention will be illustrated by the following example:

### EXAMPLE

One and the same spread is prepared starting from same ingredients but following a different process:

(% is wt. %)

Composition of emulsion:

82% fatphase

18% waterphase

Composition of fatphase

| | |
|---|---|
| 45% | partially hardened palm oil (m.p. 44° C.) |
| 4.4% | coconut oil |
| 50% | soya bean oil |
| 0.6% | lecithin |

Composition of waterphase

| | |
|---|---|
| 92% | water |
| 0.1% | citric acid |
| 0.2% | potassium sorbate |
| 5.0% | salt |
| 2.7% | whey powder |

The fat phase and the aqueous phase are obtained by mixing above ingredients. Then from the prepared phases a course pre-emulsion (premix) is prepared in a stirred vessel. Two spreads have been prepared employing processes A and B for preparing a common 80 wt. % fat spread which is presently on the market.

Process A, according to the present invention, started to use the traditional spread manufacturing technology and the traditional ingredients which are used for the preparation of a spread which, but for the final crystallisation cooling step the scraped surface heat exchanger(s) with a connected resting tube was substituted by the single-screw cooler with a connected resting tube according to the present invention. Process B was identical to process A except that it employed the traditional scraped surface heat exchanger for final crystallisation.

### Process A

At a throughput of about 10 kg/h, the coarse pre-emulsion is fed to a scraped surface heat exchanger (diameter: 0.03 m; length: 0.07 m; rotational shaft speed: 1000 rpm) and cooled down from 40° C. to about 28° C. From the scraped surface heat exchanger the product stream is fed to a pin stirrer (volume: 0.15 l; rotational shaft speed: 200 rpm) to provide working and allow crystallisation to occur. From the pin stirrer the product stream is tranferred to a single-screw cooler (diameter 0.35 m; length 1.8 m; rotational shaft speed: 100 rpm; clearance: 0.15 mm) and cooled to a temperature of about 15° C. From the single-screw cooler the product is transported via a resting tube (volume: 0.2 l) to the packing machine.

### Process B

Starting from the pre-emulsion of process A, the coarse pre-emulsion is fed at a throughput of about 10 kg/h to a scraped surface heat exchanger (diameter: 0.03 m; length 0.07 m; rotational shaft speed: 1000 rpm) and cooled down from 40° C. to about 30° C. From the scraped surface heat exchanger the product stream is fed to a pin stirrer (volume: 0.15 liter; rotational shaft speed: 200 rpm) to provide working and allow crystallisation to occur. From the pin stirrer the product stream is transferred to two other scraped surface heat exchangers (same design and operating conditions as the first scraped heat exchanger) and cooled down to a temperature of about 15° C. From the last scraped surface heat exchanger the product is transported via a resting tube (volume: 0.2 liters) to the packing machine.

### Organoleptic Assessment

The products resulting from processes A and B, product A and product B, have been submitted to an panel (n=10) for organoleptic assessment of relevant taste and structure related product attributes by comparison rating.

Table I shows only attributes for which significant differences have been found, where + and − denote the better and the lesser rating in comparison to the other spread.

All attributes have been expressed as positive desired qualities. For all eight attributes product A of the present invention scored better than product B.

TABLE I
PANEL ASSESSMENT OF SPREAD ATTRIBUTES

| POSITIVE ATTRIBUTES | Product A | Product B |
|---|---|---|
| Texture | 4+ | 0+ |
| Smooth spreading | + | − |
| No grainy mouthfeel | + | − |
| Quick melting | + | − |
| No lumpy mouthfeel | + | − |
| Taste | 4+ | 0+ |
| Creamy | + | − |
| Intensity | + | − |
| Salty | + | − |
| Lingering taste | + | − |
| Accumulated | 8+ | 0+ |
| comparison scores | | |

Further product A and product B where separately checked on passing the quality standards set for different product aspects. See Table II for scores.

TABLE II
PANEL ASSESSMENT OF PASSING SPREAD STANDARDS

| | Product A on | Product B on |
|---|---|---|
| | target say . . . | target say . . . |
| Standard for . . . | panel members | panel members |
| Consistency/Spreading | 9 | 6 |
| Appearance/Color | 8 | 2 |
| Cake baking performance | 8 | 2 |

Also by this judgment the product obtained by use of the single-screw cooler has the highest quality.

1. A processing line that is suited for the manufacture of edible W/O emulsion spreads and which line consists of at least two connected mixing and cooling devices through which line the starting materials for preparing a spread can be conducted consecutively for processing, where one of the cooling devices is a single-screw cooler of the type that is provided with a screw mounted in a barrel, where the distance of the flight of the screw to the inner wall of the barrel is 0.1-2 mm.

2. A processing line according to claim 1, where the distance of the flight of the screw to the inner wall of the barrel is 0.1-1 mm.

3. A processing line according to claim 1, which line comprises a first section with one or more devices for mixing, emulsifying, cooling, crystallisation and working the spread ingredients which section is suited for the preparation of a fat-continuous emulsion and a second section downstream from the first section which comprises the single-screw cooler.

4. A processing line according to claim 3, where the devices in the first section have been chosen from the group consisting of scraped surface heat exchangers, cooling coils, tubular heat exchangers, twin screws, pin stirrers, homogenizers, colloid mills and pressure valves.

5. A process for the manufacture of an edible fat continuous emulsion spread from usual ingredients, which process comprises a first treatment and a subsequent second treatment, where the first treatment consists of mixing the usual spread starting materials followed by a usual series of consecutive steps comprising emulsifying, cooling, crystallizing and working treatments in any suitable order and number for obtaining an intermediate liquid fat continuous emulsion, and where the second treatment of the process comprises cooling the intermediate emulsion in such way that it crystallizes and changes into a plastic emulsion spread, which cooling is performed by conducting the intermediate emulsion through a single-screw cooler of the type that is provided with a screw mounted in a barrel, where the distance of the flight of the screw to the inner wall of the barrel is 0.1-2 mm.

6. A process according to claim 5, in which the intermediate emulsion is stable, where stable is to be understood as that no visible phase separation occurs when the emulsion is left to quiescent conditions up to half an hour.

7. A process according to claim 5, where the intermediate emulsion is cooled until a hardness is obtained of which the Stevens value is at least 30 g in case the spread is meant for packing in a tub or at least 160 g when it is meant for packing in a wrapper.
